(19) United States
(12) Patent Application Publication
(10) Pub. No.: US 2022/0120899 A1
(43) Pub. Date: Apr. 21, 2022

(54) RANGING DEVICE AND MOBILE PLATFORM

(71) Applicant: SZ DJI TECHNOLOGY CO., LTD., Shenzhen (CN)

(72) Inventors: Yue YAN, Shenzhen (CN); Xiang LIU, Shenzhen (CN); Shuai DONG, Shenzhen (CN); Huai HUANG, Shenzhen (CN)

(21) Appl. No.: 17/520,209

(22) Filed: Nov. 5, 2021

Related U.S. Application Data
(63) Continuation of application No. PCT/CN2019/085723, filed on May 6, 2019.

(51) Int. Cl. G01S 17/10; G01S 7/497; G02B 6/42; G01S 7/4861

(52) U.S. Cl. CPC G01S 17/10; G01S 7/4861; G02B 6/4286; G01S 7/497

(57) ABSTRACT

A ranging device includes a light emission device configured to emit a light pulse sequence, a light guide device, a first light reception device configured to monitor an output optical power of the light emission device, and a second light reception device configured to receive a light pulse signal reflected by an object and determine a distance between the object and the ranging device based on the light pulse signal. The light guide device includes a light incident surface, a reflection surface, and a light emission surface. The reflection surface includes a first reflection surface and a second reflection surface. At least one of the first reflection surface or the second reflection surface has a curved surface shape. The light guide device is configured to receive part of radiation power emitted by the light emission device and conduct the part of the radiation power to the first light reception device.

### CROSS-REFERENCE TO RELATED APPLICATION

This application is a continuation of International Application No. PCT/CN2019/085723, filed May 6, 2019, the entire content of which is incorporated herein by reference.

### TECHNICAL FIELD

The present disclosure relates to a ranging device and a mobile platform and, more particularly, to technical fields of multi-line laser emission, power monitoring, and adjustment.

### BACKGROUND

In fields such as LIDAR, a laser diode is used as a signal source to emit a laser signal with a specific range of wavelengths and optical powers according to specific applications. In order to ensure good system performance, characteristics of laser must remain stable. However, on premise that a laser drive circuit does not change, the optical power of the laser diode shifts with a change of ambient temperature. Also, the laser diode or the drive circuit may fail during use.

When the optical power of the laser diode fluctuates, and the laser diode or the drive circuit fails during use, there will be a huge impact on a ranging device, such as inaccurate ranging, ranging failure, etc., so that the ranging device or a mobile platform equipped with the ranging device cannot work effectively, and the entire device or equipment cannot meet requirements or fails.

Therefore, it is needed to provide a ranging device and a mobile platform to solve the above technical problems. In the present disclosure, optical power of a light emission device is monitored, so that it can be monitored when the optical power of the laser diode fluctuates, and the laser diode or the drive circuit fails during use, so as to avoid abnormalities of the ranging device or the mobile platform. Also, power change of the laser diode can be effectively monitored, so as to monitor working status of the system or dynamically adjust the working status of the system.

### SUMMARY

In accordance with the disclosure, there is provided a ranging device including a light emission device configured to emit a light pulse sequence, a light guide device, a first light reception device configured to monitor an output optical power of the light emission device, and a second light reception device configured to receive a light pulse signal reflected by an object and determine a distance between the object and the ranging device based on the light pulse signal. The light guide device includes a light incident surface, a reflection surface, and a light emission surface. The reflection surface includes a first reflection surface and a second reflection surface. At least one of the first reflection surface or the second reflection surface has a curved surface shape. The light guide device is configured to receive part of radiation power emitted by the light emission device and conduct the part of the radiation power to the first light reception device.

Also in accordance with the disclosure, there is provided a ranging device including a light emission device configured to emit at least two light pulse sequences along different emission light paths, a light guide device, a first light reception device configured to monitor an output optical power of the light emission device, and a second light reception device configured to receive a light pulse signal reflected by an object and determine a distance between the object and the ranging device based on the received light pulse signal. The light guide device is configured to receive part of radiation power of the at least two light pulse sequences and conduct the part of the radiation power to the first light reception device.

### BRIEF DESCRIPTION OF THE DRAWINGS

In order to explain the embodiments of the present disclosure more clearly, reference is made to the accompanying drawings, which are used in the description of the embodiments. Obviously, the drawings in the following description are some embodiments of the present disclosure, and other drawings can be obtained from these drawings without any inventive effort for those of ordinary skill in the art.

FIG. 1 is a schematic diagram of a light path structure of a light guide device according to an embodiment of the present disclosure.

FIG. 2 is a schematic structural diagram of an apertured reflector according to an embodiment of the present disclosure.

FIG. 3 is a schematic structural diagram of a peak hold circuit according to an embodiment of the present disclosure.

FIG. 4 is a schematic diagram showing a relationship between a light pulse and a peak output according to an embodiment of the present disclosure.

FIG. 5 is a schematic diagram of sampling timing according to an embodiment of the present disclosure.

FIG. 6 is a schematic diagram showing a relationship between a peak circuit monitoring value and a temperature according to an embodiment of the present disclosure.

FIG. 7 is a schematic side view of a light guide device according to an embodiment of the present disclosure.

FIG. 8 is a schematic perspective view of a light guide device according to an embodiment of the present disclosure.

FIG. 9 is a schematic diagram of a light path structure of a light guide device according to an embodiment of the present disclosure.

FIG. 10 is a schematic perspective view of a light guide device according to an embodiment of the present disclosure.

FIG. 11 is a schematic block diagram of a ranging device according to an embodiment of the present disclosure.

FIG. 12 is a schematic diagram showing an embodiment in which a ranging device employs a coaxial optical path.

### REFERENCE NUMERALS

Laser diode 1, 2, 3;

First reflection surface 4;

Second reflection surface 5;

Light incident surface 6;

Light emission surface 7;

Signal emission light 8;

Non-signal reflected light 9;

Apertured reflector 10;

Circular ring 11;

Light guide device 12;

Ranging device 100, 200, Detection object 201, Scanner 202;

Transmission circuit 110, Transmitter 203;

Reception circuit 120, Collimation element 204;

Sampling circuit 130, Detector 205;

Computation circuit 140, Light path changing element 206;

Control circuit 150, Ranging module 210, Rotation axis 209;

Scanner 160, First optical element 214, Second optical element 215;

Driver 216, Collimated light beam 219;

Light 211, 213, Return light 212, Controller 218.

### DETAILED DESCRIPTION OF THE EMBODIMENTS

The technical solutions in the embodiments of the present disclosure will be described in detail with reference to the accompanying drawings. Obviously, the described embodiments are only some of rather than all the embodiments of the present disclosure. Based on the described embodiments, all other embodiments obtained by those of ordinary skill in the art without inventive effort shall fall within the scope of the present disclosure.

A light emission device provided in the various embodiments of the present disclosure can be applied to a ranging device, and the ranging device can be an electronic device such as a LIDAR or a laser ranging device. In some embodiments, the ranging device is configured to sense external environment information, such as distance information, orientation information, reflection intensity information, speed information, etc. of an environmental target. In one implementation manner, the ranging device can detect distance of a detection object to the ranging device by measuring time of light propagation, that is, time-of-flight (TOF), between the ranging device and the detection object. The ranging device can also detect the distance from the detection object to the ranging device by other techniques, such as a ranging method based on phase shift measurement or a ranging method based on frequency shift measurement, which is not limited herein.

Distance and orientation detected by a ranging device 200 can be used for remote sensing, obstacle avoidance, surveying and mapping, modeling, navigation, etc. In some embodiments, the ranging device according to the embodiments of the present disclosure can be applied to a mobile platform, and the ranging device can be mounted at a platform body of the mobile platform. The mobile platform with the ranging device can measure external environment, for example, to measure distance between the mobile platform and an obstacle for obstacle avoidance and other purposes, and to perform two-dimensional or three-dimensional surveying and mapping of the external environment. In some embodiments, the mobile platform includes at least one of an unmanned aerial vehicle, a car, a remote control vehicle, a robot, or a camera. When the ranging device is applied to an unmanned aerial vehicle, the platform body is a vehicle body of the unmanned aerial vehicle. When the ranging device is applied to a car, the platform body is a vehicle body of the car. The car can be a self-driving car or a semi-self-driving car, which is not limited herein. When the ranging device is applied to a remote control vehicle, the platform body is a vehicle body of the remote control vehicle. When the ranging device is applied to a robot, the platform body is the robot. When the ranging device is applied to a camera, the platform body is the camera itself.

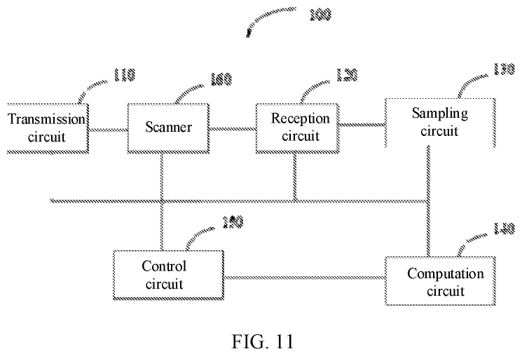

For better understanding, a ranging workflow will be described with examples in conjunction with a ranging device 100 shown in FIG. 11.

As shown in FIG. 11, the ranging device 100 includes a transmission circuit 110, a reception circuit 120, a sampling circuit 130, and a computation circuit 140.

The transmission circuit 110 can emit a light pulse sequence (e.g., a laser pulse sequence). The reception circuit 120 can receive the light pulse sequence reflected by a detection object (also referred to as a “target object” or “detected object”) and perform photoelectric conversion on the light pulse sequence to obtain an electrical signal, and then the electrical signal is processed and output to the sampling circuit 130. The sampling circuit 130 can sample the electrical signal to obtain a sampling result. The computation circuit 140 can determine distance between the ranging device 100 and the detection object based on the sampling result of the sampling circuit 130.

In some embodiments, the ranging device 100 also includes a control circuit 150, which can control other circuits, for example, can control operation time of each circuit and/or set parameters for each circuit.

It should be noted that although the ranging device shown in FIG. 11 includes a transmission circuit, a reception circuit, a sampling circuit, and a computation circuit, and is configured to emit a light beam for detection, the embodiments of the present disclosure are not limited thereto. Number of any one of the transmission circuit, the reception circuit, the sampling circuit, and the computation circuit may also be at least two, which are configured to emit at least two light beams in same direction or in different directions. The at least two light beams may be emitted simultaneous or may be emitted at different times. In some embodiments, light emitting chips in the at least two transmission circuits are packaged in same module. For example, each transmission circuit includes a laser emitting chip, and dies of the laser emitting chips in the at least two transmission circuits are packaged together and housed in same package space.

In some implementations, as shown in FIG. 11, the ranging device 100 also includes a scanner 160 for changing propagation direction of at least one light pulse sequence emitted by the transmission circuit.

A module including the transmission circuit 110, the reception circuit 120, the sampling circuit 130, and the computation circuit 140, or a module including the transmission circuit 110, the reception circuit 120, the sampling circuit 130, the computation circuit 140, and the control circuit 150 may be referred to as a ranging module, which can be independent of other modules, such as the scanner 160.

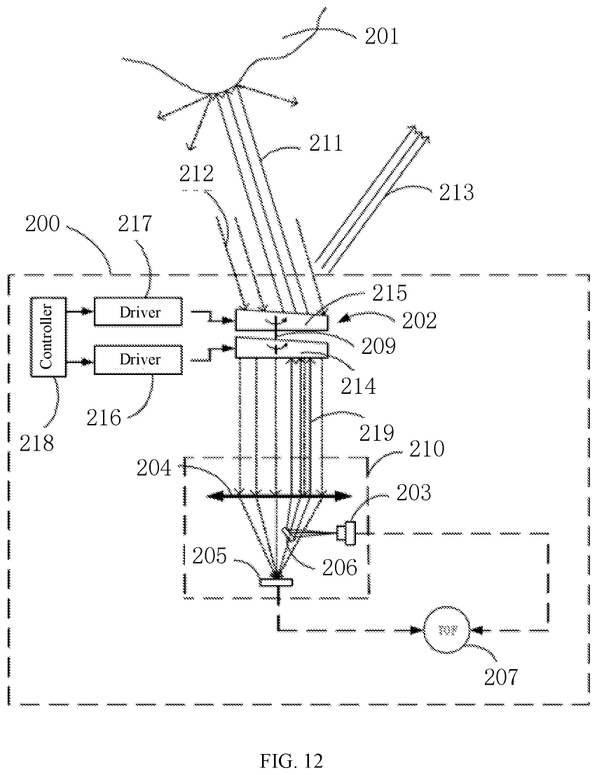

A coaxial light path can be used in the ranging device, that is, the light beam emitted by the ranging device and the reflected light beam share at least part of the light path within the ranging device. For example, after at least one laser pulse sequence emitted by the transmission circuit changes its propagation direction and emits through the scanner, the laser pulse sequence reflected by the detection object passes through the scanner and then enters the reception circuit. An off-axis light path can also be used in the ranging device, that is, the light beam emitted by the ranging device and the reflected light beam are respectively transmitted along different light paths within the ranging device. FIG. 12 shows a schematic diagram of a ranging device 200 using a coaxial light path according to an embodiment of the present disclosure.

The ranging device 200 includes a ranging module 210, which includes a transmitter 203 (which may include the transmission circuit described above), a collimation element 204, a detector 205 (which may include the reception circuit, the sampling circuit, and the computation circuit described above), and a light path changing element 206. The ranging module 210 is configured to emit the light beam, receive the reflected light, and convert the reflected light into the electrical signal. The transmitter 203 can be configured to emit the light sequence. In some embodiments, the transmitter 203 may emit the laser pulse sequence. For example, a laser beam emitted by the transmitter 203 is a narrow-bandwidth beam with a wavelength outside visible light range. The collimation element 204 is arranged on transmission light path of the transmitter, and is configured to collimate the light beam emitted from the transmitter 203 and collimate the light beam emitted from the transmitter 203 into parallel light output to the scanner. The collimation element is also configured to converge at least part of the reflected light reflected by the detection object. The collimation element 204 may be a collimating lens or another element capable of collimating the light beam.

In the embodiments shown in FIG. 12, the transmission light path and the reception light path within the ranging device are merged before the collimation element 204 by the light path changing element 206, so that the transmission light path and the reception light path can share the same collimation element, which makes the light path more compact. In some other implementations, the transmitter 203 and the detector 205 may respectively use their own collimation elements, and the light path changing element 206 is arranged on the light path behind the collimation element.

In the embodiment shown in FIG. 12, since beam aperture of the light beam emitted by the transmitter 203 is small, and beam aperture of the reflected light received by the ranging device is large, the light path changing element can use a small-area reflector to merge the transmission light path and the reception light path. In some other implementations, the light path changing element may also use a reflector with a through hole, where the through hole is used to transmit emitted light of the transmitter 203 and the reflector is used to reflect the reflected light to the detector 205, which can reduce block of the reflected light from a support of a small reflector in case of using the small reflector.

In the embodiments shown in FIG. 12, the light path changing element is deviated from an optical axis of the collimation element 204. In some other implementations, the light path changing element may also be located on the optical axis of the collimation element 204.

The ranging device 200 also includes a scanner 202 arranged on the transmission light path of the ranging module 210. The scanner 202 is configured to change transmission direction of a collimated light beam 219 emitted by the collimation element 204 and project it to external environment. The reflected light is projected to the collimation element 204, and is converged on the detector 205 through the collimation element 204.

In some embodiments, the scanner 202 may include at least an optical element for changing propagation path of the light beam, and the optical element may change the propagation path of the light beam by reflecting, refracting, diffracting, etc. For example, the scanner 202 includes a lens, a reflector, a prism, a galvanometer, a grating, a liquid crystal, an optical phased array, or any combination of the above. In some embodiments, at least some of the optical elements are movable, for example, the at least some of the optical elements are driven to move by a drive module, and the movable optical element can reflect, refract or diffract the light beam to different directions at different times. In some embodiments, the multiple optical elements of the scanner 202 can rotate or vibrate around a common rotation axis 209, and each rotating or vibrating optical element is configured to continuously change the propagation direction of an incident light beam. In some embodiments, the multiple optical elements of the scanner 202 may rotate at different rotation speeds or vibrate at different speeds. In some other embodiments, the at least some of the optical elements of the scanner 202 may rotate at substantially the same rotation speed. In some embodiments, the multiple optical elements of the scanner may also rotate around different axes. In some embodiments, the multiple optical elements of the scanner may also rotate in the same direction or in different directions; or vibrate in the same direction or in different directions, which is not limited herein.

In some embodiments, the scanner 202 includes a first optical element 214 and a driver 216 connected to the first optical element 214. The driver 216 is configured to drive the first optical element 214 to rotate around the rotation axis 209, such that the first optical element 214 changes the direction of the collimated light beam 219, and the first optical element 214 projects the collimated light beam 219 to different directions. In some embodiments, angle between the direction of the collimated light beam 219 changed by the first optical element and the rotation axis 209 varies with the rotation of the first optical element 214. In some embodiments, the first optical element 214 includes a pair of opposing non-parallel surfaces through which the collimated light beam 219 passes. In some embodiments, the first optical element 214 includes a prism that varies in thickness along at least a radial direction. In some embodiments, the first optical element 214 includes a wedge angle prism that refracts the collimated light beam 219.

In some embodiments, the scanner 202 also includes a second optical element 215 that rotates around the rotation axis 209, and the rotation speed of the second optical element 215 is different from the rotation speed of the first optical element 214. The second optical element 215 is configured to change the direction of the light beam projected by the first optical element 214. In some embodiments, the second optical element 215 is connected to another driver 217 that drives the second optical element 215 to rotate. The first optical element 214 and the second optical element 215 can be driven by the same or different drivers, so that the rotation speed and/or rotation direction of the first optical element 214 and the second optical element 215 are different, thereby projecting the collimated light beam 219 to different directions in outside space, and a larger space can be scanned. In some embodiments, a controller 218 controls the drivers 216 and 217 to drive the first optical element 214 and the second optical element 215, respectively. The rotation speeds of the first optical element 214 and the second optical element 215 may be determined according to area and pattern expected to be scanned in actual applications. The drivers 216 and 217 may include motors or other drivers.

In some embodiments, the second optical element 215 includes a pair of opposing non-parallel surfaces through which the light beam passes. In some embodiments, the second optical element 215 includes a prism that varies in thickness along at least a radial direction. In some embodiments, the second optical element 215 includes a wedge angle prism.

In some embodiments, the scanner 202 also includes a third optical element (not shown) and a driver for driving the third optical element to move. For example, the third optical element includes a pair of opposing non-parallel surfaces through which the light beam passes. In some embodiments, the third optical element includes a prism that varies in thickness along at least a radial direction. In some embodiments, the third optical element includes a wedge angle prism. At least two of the first, second, and third optical elements rotate at different rotation speeds and/or rotation directions.

Each optical element in the scanner 202 can rotate to project light to different directions, such as directions of lights 211 and 213, so that a space around the ranging device 200 is scanned. When the projected light 211 projected by the scanner 202 hits a detection object 201, part of the light is reflected by the detection object 201 to the ranging device 200 in a direction opposite to the projected light 211. Return light 212 reflected by the detection object 201 is incident to the collimation element 204 after passing through the scanner 202.

The detector 205 and the transmitter 203 are arranged on the same side of the collimation element 204, and the detector 205 is configured to convert at least part of the reflected light passing through the collimation element 204 into an electrical signal.

In some embodiments, each optical element is plated with an anti-reflection coating. For example, thickness of the anti-reflection coating is equal to or close to wavelength of the light beam emitted by the transmitter 203, which can increase intensity of the transmitted light beam.

In some embodiments, a filter layer is plated on an element surface located on beam propagation path in the ranging device, or a filter is provided on the beam propagation path, which is configured to at least transmit wavelength band of the beam emitted by the transmitter and reflect other wavelength bands, so as to reduce noise caused by ambient light to receiver.

In some embodiments, the transmitter 203 may include a laser diode, and emit a nanosecond level laser pulse through the laser diode. For example, laser pulse receiving time can be determined, for example, by detecting rising edge time and/or falling edge time of an electrical signal pulse. As such, the ranging device 200 can calculate time of flight (TOF) using pulse receiving time information and pulse sending time information, so as to determine the distance between the detection object 201 and the ranging device 200.

In order to monitor output optical power of the transmission circuit, a light guide device and a peak hold circuit are also provided in the embodiments of the present disclosure. The light guide device is configured to collect part of emitted light of the transmission circuit, and the peak hold circuit is configured to perform peak monitoring of light beams collected by the light guide device. It can be understood that the light guide device and the peak hold circuit provided in the embodiments of the present disclosure are not limited to being applied to the ranging device described above, and can also be applied to other devices, which is not limited herein.

In applications such as LIDAR, in order to improve signal density, multiple laser diodes are employed in some embodiments of the present disclosure, or multiple laser diode chips are packaged into a device as a signal source to emit multi-line lasers, where the laser emitted by each laser diode can be separately controlled. When drive voltage is the same, emission power of the same laser changes with temperature of the laser diode. Also, as working time increases, the laser diode is continuously aged, and the emission power of the laser also gradually decreases. There are also differences in the emission powers among different lines of lasers due to performance differences, optical structure positions, and different aging speeds of different laser diodes. In order to ensure consistency and stability of LIDAR performance, it is needed to monitor and continuously adjust the emission powers of the multi-line lasers in real time.

In order not to affect original optical signal, a very small part of the laser is intercepted through the light guide device or the reflector, which is transmitted out, and converted into the electrical signal through a photoelectric converter (such as a photodiode (PD)). A peak power monitoring is performed, and monitored power is used to be compared with a target power to adjust laser emission in real time. For multi-line laser emission, light path structure of the light guide device is optimized, so that powers from different lines of laser diodes in a spatial distribution collected by the same PD has good consistency. As such, only one PD is needed to effectively monitor power changes of multi-line laser diodes at the same time. A non-signal reflected light can also be used to perform the power monitoring in a light path system, which simplifies structure and system. This scheme is mainly applied to products such as LIDAR, laser rangefinder, or optical fiber communication.

In an application scenario where the transmission circuit is configured to emit different light beams along different light paths, the light path structure of the light guide device can be optimized in some embodiments of the present disclosure, so that the powers from different lines of laser diodes in the spatial distribution collected by the same PD has good consistency. In some examples, monitoring can also be performed by directly using the non-signal reflected light in the system. A second light reception device based on a single PD performs time-division multiplexing to monitor and adjust working status of different lines of laser diodes in real time, which ensures performance consistency and stability thereof.

In order not to affect the original optical signal, a very small part of the laser is intercepted through the light guide device or the reflector, which is transmitted out, and converted into the electrical signal through the photodiode (PD). The peak power monitoring is performed, and the monitored power is used to be compared with the target power to adjust laser emission. For multi-line laser emission, the light path structure of the light guide device is optimized, so that the powers from different lines of laser diodes in the spatial distribution collected by the same PD has good consistency. As such, only one PD is needed to effectively monitor the power changes of multi-line laser diodes at the same time. The non-signal reflected light in the light path system can also be used to perform the power monitoring, which simplifies the structure and system.

According to the disclosure, consistency in the emission power with difference in at least one of temperature, working time, or line is ensured through designing the light path structure of the light guide device or directly using the non-signal reflected light in the light path system for performing time-sharing monitoring of multi-line laser power by a single PD, comparing the monitored signal with the target power, and using an error value to adjust the emission power in real time.

In some embodiments, a scheme of laser power monitoring in the LIDAR is proposed, in which the power changes of multi-line laser diodes can be effectively monitored, so as to monitor or dynamically adjust the working status of the system. In some embodiments, radiation powers of multiple lasers in the LIDAR can be monitored at the same time by using one hardware/structure scheme, i.e., structure/hardware multiplexing.

In some embodiments, the ranging device includes the light emission device, the light guide device, a first light reception device, and the second light reception device. The light emission device is configured to emit at least one light pulse sequence. The second light reception device is configured to receive a light pulse signal reflected by an object, and determine distance between the object and the ranging device based on the received light pulse signal. Part of the radiation power emitted by the light emission device is incident to the light guide device, and the light guide device conducts the part of the radiation power to the first light reception device. The light guide device includes a light incident surface, a reflection surface, and a light emission surface, where the reflection surface includes a first reflection surface and a second reflection surface, and at least one of the first reflection surface or the second reflection surface has a curved surface shape. The first light reception device is configured to monitor the output optical power of the light emission device.

In order to obtain the light guide device, a light guide structure is designed to transmit part of the radiation power of the laser diode to the detector for detection. Structure of the light guide device can be optimized to make a multi-line power ratio detected by the detector consistent, which is convenient for hardware processing.

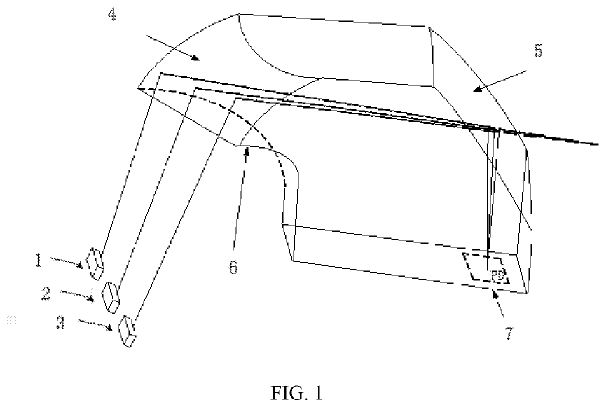

The light path structure of the light guide device is optimized, so that the powers from different lines of laser diodes in the spatial distribution collected by the same PD has good consistency. The light path structure is as follows (in an example with three lines, but it is not limited to three lines): because size of a photosensitive surface of the PD is limited, and the light emitted by the laser diode is divergent light, if a first reflection surface 4 and a second reflection surface 5 in FIG. 1 are flat, after passing through the light guide device, power received by the PD from edges of the multi-line laser diodes is smaller, and that from middle is larger. The first reflection surface 4 and the second reflection surface 5 are made into paraboloids using characteristics of parallel light focusing on a focal point of the paraboloid in space, so that the laser diodes at different positions in the space are mirrored to vicinity of a same position through the curved first reflection surface 4, and the curved second reflection surface 5 converts the divergent light of the laser diodes into parallel light, which is then received by the PD.

For example, FIG. 1 is a schematic diagram of the light path structure of the light guide device according to an embodiment of the present disclosure, which includes the light emission device, including laser diodes 1, 2, 3, the light guide device, the first light reception device, and the second light reception device (not shown). The laser diodes 1, 2, 3 emit at least one light pulse sequence, for example, one light pulse sequence is emitted respectively, and three light pulse sequences are emitted. The second light reception device is configured to receive the light pulse signal reflected by the object, and determine the distance between the object and the ranging device based on the received light pulse signal. Part of the radiation power emitted by the laser diodes 1, 2, 3 is incident to the light guide device, the light guide device conducts the part of the radiation power to the first light reception device. The light guide device includes a light incident surface 6, reflection surfaces 4, 5, and a light emission surface 7, where the reflection surfaces includes the first reflection surface 4 and the second reflection surface 5, and at least one reflection surface of the first reflection surface 4 and the second reflection surface 5 has a curved surface shape. The first light reception device is configured to monitor the output optical power of the laser diodes 1, 2, 3.

In some embodiments, the light emission device may include one laser diode. The light emission device includes only one laser diode 1.

In some embodiments, the light emission device includes at least two laser diodes. The light emission device includes only laser diodes 1, 2, or three laser diodes 1, 2, 3 or more.

In some embodiments, transmission light paths of at least two laser diodes are not parallel. Nevertheless, the emitted light can still be incident to the first light reception device through the light guide device.

In some embodiments, at least two laser diodes are arranged along a straight line. As shown in FIG. 1, the laser diodes 1, 2, 3 are arranged along a straight line.

In some embodiments, at least two laser diodes emit light in sequence (i.e., one after another), and the light from the at least two laser diodes is incident to the same first light reception device through the light guide device. As shown in FIG. 1, the laser diodes 1, 2, 3 emit light in sequence, and the light respectively enter the first light reception device through the light guide device.

In some embodiments, the light incident surface 6 is a cylindrical surface, and incident light received by the light incident surface is perpendicular to the light incident surface.

In some embodiments, the straight line is parallel to a central axis of the cylindrical surface. The straight line where the laser diodes 1, 2, 3 are arranged is parallel to the central axis of the cylindrical surface of the light incident surface 6.

In some embodiments, the light emission surface includes a frosted surface. The light emission surface 7 is frosted.

The light incident surface 6 is a cylindrical surface, and the central axis of the cylindrical surface is a connection line of the multi-line laser diodes. The light emission surface 7 is frosted, so that the light emitted by the laser diode is more uniformly received by the PD, which reduces sensitivity of received optical power of the PD to structural tolerance and mounting tolerance of the light guide device.

In some embodiments, the first reflection surface mirrors the light incident from the light emission device to the light guide device to the vicinity of the same position.

In some embodiments, the second reflection surface converts the divergent light incident from the light emission device to the light guide device into parallel light.

As shown in FIG. 1, the curved surface 4 and the curved surface 5 are made into paraboloids since a paraboloid can focus parallel light in the space to a focal point of the paraboloid, so that the laser diodes at different positions in the space are mirrored to the vicinity of the same position through the curved surface 4, and the curved surface 5 converts the divergent light of the laser diodes into parallel light, which is then received by the first light reception device.

In some embodiments, the ranging device calibrates the laser diode according to output power of the light reception device. As shown in FIG. 1, the ranging device calibrates the laser diodes 1, 2, 3 according to the power received by the first light reception device, that is, the ranging device adjusts drive power of the laser diodes 1, 2, 3 according to real-time value and change value of the power thereof, so as to meet needs of the ranging device.

In some embodiments, the first reflection surface is close to the light incident surface, which has a curved surface shape. As shown in FIG. 1, the first reflection surface 4 is close to the light incident surface 6, and the first reflection surface has a curved surface shape.

In some embodiments, the curved surface shape is a paraboloid of revolution (circular paraboloid), and its focal point is a mirror image point of a center position of the first light reception device with respect to the second reflection surface. As shown in FIG. 1, the first reflection surface 4 is formed by the paraboloid of revolution, and its focal point is located at the mirror image point of the center position of the first light reception device with respect to the second reflecting surface 5. According to this arrangement, the light incident to the first reflection surface 4 will converge in a focal direction of the first reflection surface 4. Considering that a focal point of the first reflection surface 4 and the center position of the light emission device are mirror image points with respect to the second reflection surface 5, the light incident to the first reception surface 4 will converge in a center direction of the first light reception device.

In some embodiments, the second reception surface is close to the light emission surface, which has a curved surface shape. As shown in FIG. 1, the second reflection surface 5 is close to the light emission surface 7, and the second reflection surface 5 has a curved surface shape.

In some embodiments, the curved surface shape is the paraboloid of revolution, and its focal point is a mirror image point of a center position of the light emission device with respect to the first reflection surface. As shown in FIG. 1, the second reflection surface 5 is formed by the paraboloid of revolution, and its focal point is located at the mirror image point of the center position of the light emission device with respect to the first reflecting surface 4. According to this arrangement, the light incident to the second reflection surface 5 will converge in a focal direction of the second reflection surface 5. Considering that a focal point of the second reflection surface 5 and the center position of the light emission device are mirror image points with respect to the first reflection surface 4, the light emitted by the light emission device will emit in a same direction through reflection of the second reflection surface 5, or converge into a same position.

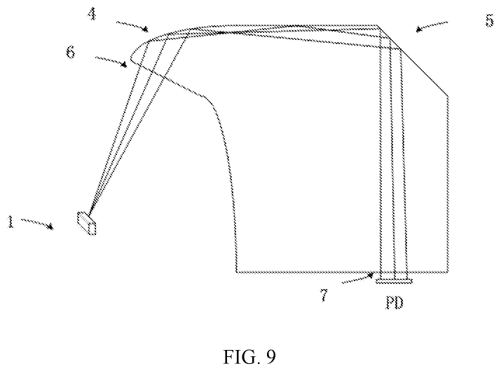

As for the structure of the light guide device, the present disclosure provides a variety of design schemes for different situations. Regardless of whether the light guide device is applied to a single-line laser light guide or a multi-line laser light guide, the purpose is to transmit part of the radiation of the laser diode to position of the detector for detection. For example, when the single-line laser light is guided, its structure is as shown in FIG. 9. The light emitted by the laser diode 1 passes through the light incident surface 6 and is finally received by the PD. A middle part of the light beam received by the light incident surface 6 of the light guide device is perpendicular to the light incident surface, which reduces sensitivity of light input to structural assembly errors. The light emission surface 7 can be frosted, so that the PD receives more uniform light, which further reduces the sensitivity of the light guide device to the structural tolerance. In the light guide device, the first reflection surface 4 is a curved structure, and the second reflection surface 5 is a planar structure. For a single-line laser diode, shapes of the first reflection surface 4 and the second reflection surface 5 are matched, so that the light emitted by the laser diode can be transmitted to a range near a center point of the PD to meet requirements.

As for a multi-line laser device, the light path structure of the light guide device is optimized, so that the powers from different lines of laser diodes in the spatial distribution collected by the same PD has good consistency. The light path structure is as follows (in an example with three lines, but it is not limited to three lines): because the size of the photosensitive surface of the PD is limited, and the light emitted by the laser diode is divergent light, if the first reflection surface 4 and the second reflection surface 5 in FIG. 1 are flat, after passing through the light guide device, the power received by the PD from the edges of the multi-line laser diodes is smaller, and that from the middle is larger. Even in a structure shown in FIG. 9, where the first reflection surface 4 is set as a curved surface and the second reflection surface is set as a flat surface, it is still difficult to meet the requirements due to a limitation of the size of the PD photosensitive surface. The first reflection surface 4 and the second reflection surface 5 are made into the paraboloids using the characteristics of parallel light focusing on the focal point of the paraboloid in the space, so that the laser diodes at different positions in the space are mirrored to the vicinity of the same position through the curved first reflection surface 4, and the curved second reflection surface 5 converts the divergent light of the laser diodes into parallel light, which is then received by the PD. Also, the laser incident surface is a cylindrical surface, and the central axis of the cylindrical surface is the connection line of the multi-line laser diodes, which can reduce sensitivity of laser input to the structural tolerance or the mounting tolerance. The light emission surface is frosted, so that the light emitted by the laser diode is more uniformly received by the PD, which reduces the sensitivity of the received optical power of the PD to the structural tolerance and the mounting tolerance of the light guide device.

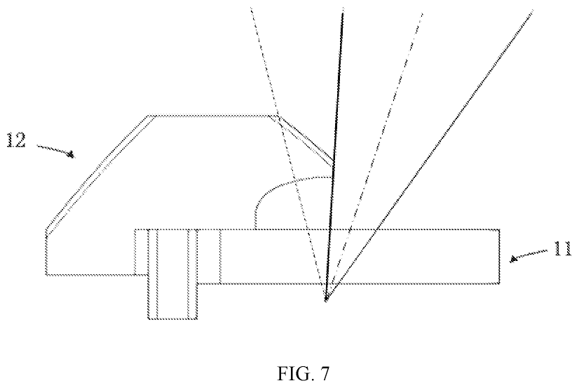

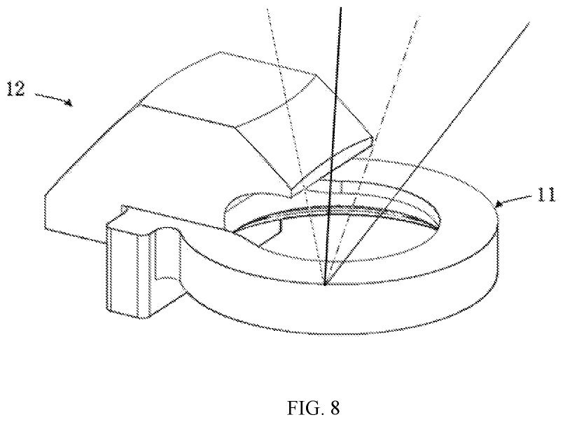

In some embodiments, a positioning member is also provided, which is configured to fix position of the light emission device and position of the light guide device to each other. In an example, the positioning member is a circular ring and is fixed with the position of the light guide device. The light emission device is clamped in the circular ring, and the circular ring is configured to position the light emission device, so that the light emission device and the light guide device are fixed to each other. As shown in FIGS. 7 and 8, for example, light beam emission optical axis of the light emission device (shown by dotted line in the figure) and a central axis of the circular ring (that is, an axis perpendicular to the ring and passing through the center of the ring) form a certain angle. The light guide device is located at one side of the circular ring, and edge part of the light emitted by the light emission device is incident into the light guide device. Positional relationship between the light and a circular ring 11 is shown in FIGS. 7 and 8. Positions of the light emission device and the circular ring 11 are fixed to each other. For example, the two may be connected by a fixation device, or may not be connected by a fixation device, and the circular ring 11 can position the light emission device.

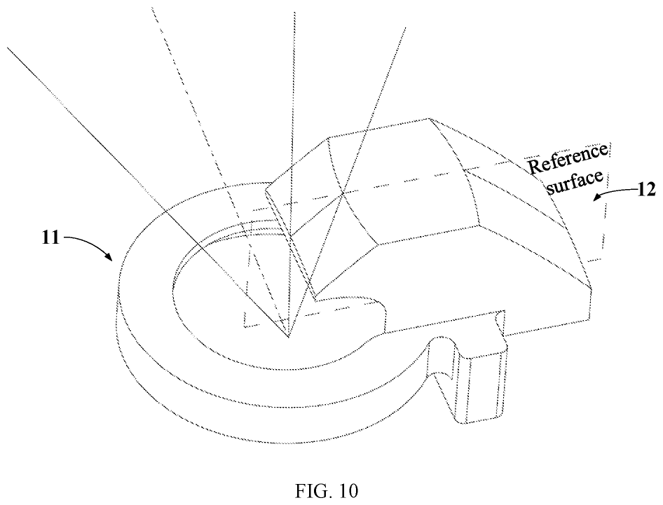

In some embodiments, the circular ring and the light guide device are fixed to each other by gluing or are integrally formed. As shown in FIGS. 7, 8, and 10, the circular ring 11 and a light guide device 12 are fixed to each other by gluing or are integrally formed. The circular ring is also configured to position a laser diode package.

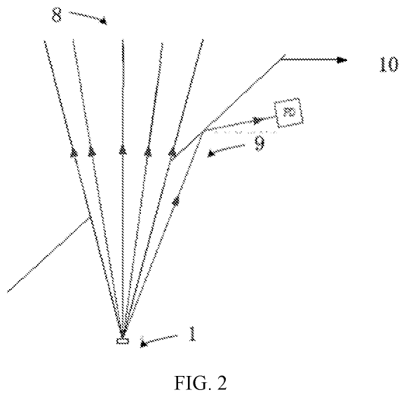

In some examples, the light received by the first light reception device is non-signal light, which refers to part of the light emitted by the light emission device that is not emitted from the ranging device. As shown in FIG. 2, which includes signal emission light 8, non-signal reflected light 9, apertured reflector 10, and PD. Stray light in the structure is used in this structure. Power radiated by the light emission device is not all emitted, and a part of the light will be lost inside the structure and become stray light to form the non-signal reflected light 9. In FIG. 2, a part of the light of the light emission device is turned into stray light through the apertured reflector, and output power of the PD can be monitored by detecting power of this part of scattered light.

The structure of the light guide device is not limited to the above-mentioned shape. A light guide method used herein is mainly to send a fixed part (which can be a very low ratio, such as 1‰) of laser light emitted by a laser tube to a photoelectric sensor, such as the PD in FIG. 2 as an example. The photoelectric sensor can also be APD, SIPM, or PMT. The photoelectric sensor detects light intensity as a detection method of actual laser output power. Although the apertured reflector 10 in FIG. 2 is used to realize splitting of signal reflected light and the non-signal reflected light, way of splitting is not limited to the above-mentioned optical devices, as long as a fixed part of the laser light emitted by the laser can be sent to the optical device. Specifically, in FIG. 2, power monitoring is realized through the non-signal reflected light. Signal light of the system passes through the apertured reflector 10, and a small part of excess laser light is reflected by the reflector and received by the PD.

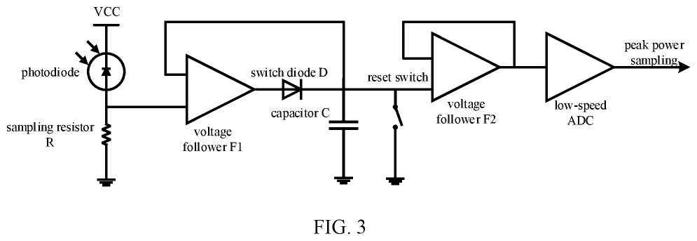

In some embodiments, the first light reception device includes the photoelectric converter, the peak hold circuit, and the sampling circuit. The photoelectric converter is configured to convert optical signal received by the first light reception device into the electrical signal. The peak hold circuit is configured to hold peak value of the electrical signal. The sampling circuit is configured to sample the peak value of the electrical signal. As shown in FIG. 3, the peak hold circuit is configured to hold voltage peak value of the electrical signal measured by the PD, and the sampling circuit is configured to sample the voltage peak value of the electrical signal.

In an example, the peak hold circuit includes a first voltage follower, a capacitor, a second voltage follower, and a reset switch. The first voltage follower is configured to store a voltage signal measured by the photoelectric converter in the capacitor. The second voltage follower is configured to input the voltage signal of the capacitor to the sampling circuit. The reset switch is configured to reset the capacitor before each light pulse is emitted. A voltage follower is employed to store the voltage peak value of the electrical signal measured by the PD in the capacitor, so that the sampling circuit can use a low-speed analog-to-digital converter to sample the peak value instead of buying a high-speed analog-to-digital converter, which can reduce costs.

In some embodiments, the peak hold circuit includes a resistor, the capacitor, and a voltage follower circuit. As shown in FIG. 3, the peak hold circuit includes a sampling resistor R, a capacitor C, a voltage follower circuit, and a low-speed analog-to-digital converter (ADC). The voltage follower circuit includes a voltage follower F1 and a voltage follower F2.

In some embodiments, the resistor is the sampling resistor, one end of which is connected to the photoelectric converter and an input end of the voltage follower circuit, and the other end is grounded. As shown in FIG. 3, one end of the sampling resistor R is connected to the photoelectric converter which is the photodiode, and the other end is grounded.

In some embodiments, one end of the voltage follower circuit is connected to the sampling resistor and the photoelectric converter, and the other end is connected to the low-speed analog-to-digital converter. The low-speed analog-to-digital converter outputs sampled peak power. As shown in FIG. 3, one end of the voltage follower circuit is connected to the sampling resistor R and the photodiode, and the other end is connected to the low-speed ADC. The low-speed ADC outputs the peak power obtained by sampling.

In some embodiments, the voltage follower circuit includes the first voltage follower and the second voltage follower. The first voltage follower follows the voltage signal of the sampling resistor, and uses the voltage signal to charge the capacitor. The second voltage follower also includes the reset switch, which controls the second voltage follower to input the signal in the capacitor to the low-speed analog-to-digital converter. As shown in FIG. 3, the voltage follower circuit includes the voltage follower F1 and the voltage follower F2. The voltage follower F1 follows the voltage signal of the sampling resistor R, and charges the capacitor C according to the voltage signal. The voltage follower F2 includes the reset switch, which controls the voltage follower F2 to input the signal in the capacitor C to the low-speed ADC.

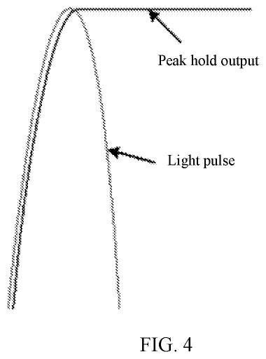

In some embodiments, the first voltage follower also includes a switch diode. One end of the switch diode is connected to an output end of the first voltage follower, and the other end is connected to an input end of the second voltage follower. As shown in FIG. 3, the voltage follower F1 also includes a switch diode D. One end of the switch diode D is connected to an output end of the voltage follower F1, and the other end is connected to an input end of the voltage follower F2. After the PD receives the emitted optical signal, the peak hold circuit processes the optical signal of the PD. When the laser diode emits the laser light, the PD monitors the emitted light pulse and converts into current. The sampling resistor R further converts a current pulse signal into the voltage signal, thereby turning on the voltage follower F1 and the switch diode D, and then charging the capacitor C. When the capacitor C is charged to be consistent with peak value of an input pulse signal, the switch diode D is turned off, as shown in FIG. 4, and at this time, the low-speed ADC can sample the peak power.

In some embodiments, the first light reception device monitors the optical signals from different laser diodes in a time-sharing monitoring manner. The next light emission power of the light emission device is adjusted according to the previous light emission power measured by the peak hold circuit. The at least two laser diodes emit light in sequence, and the at least two laser diodes include a first laser diode and a second laser diode. After the first laser diode emits light, peak power thereof is obtained through the peak hold circuit. The second laser diode emits light after the peak hold circuit is reset, and peak power thereof is obtained through the same peak hold circuit. The peak power obtained by the first laser diode is configured to adjust the next light emission power of the first laser diode, or is configured to adjust the light emission power of the second laser diode after the first laser diode.

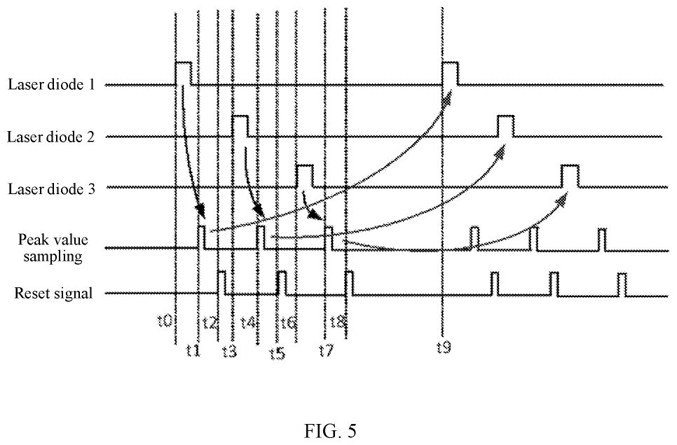

A schematic diagram of sampling timing in an example is shown in FIG. 5. The laser diode 1 emits light at time t0, peak value sampling of the laser diode 1 is performed at time t1 after the light emission is completed, and the peak hold circuit is reset at time t2 after the sampling is completed. Then the laser diode 2 emits light at time t3, peak power of the laser diode 2 is collected at time t4, and the peak hold circuit is reset at time t5. The laser diode 3 emits light at time t6, peak power of the laser diode 3 is collected at time t7, and reset is performed again at time t8. After one cycle is completed, a next cycle is started at time t9. The peak power collected at time t1 is compared with the target power, and the light emission power at time t9 is adjusted according to the error value. Adjustment of the light emission power of the laser diodes 2 and 3 can be similarly performed by analogy.

Through such a time-sharing method, the same peak hold circuit can monitor each pulse power of each line of laser in real time, and the next emission power of the laser is then adjusted through calculation, so as to realize consistency of light emission among different temperatures, different working time, and different lasers.

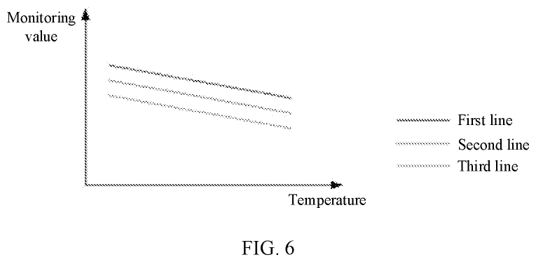

Although the light guide device is designed to maintain consistency among multiple lines as much as possible, due to manufacturing process and other reasons, there are still certain differences among the light paths of different lines. In addition, when the same laser diode emits the same power, the power monitored by the peak hold circuit is also different at different temperatures. Therefore, it is needed to calibrate the peak hold circuit first before starting to use. There are individual differences when each line of laser emits light, and the light paths passing through the light guide device are also slightly different. When it is calibrated, a first line is first controlled to emit light, and data such as monitoring value of the peak hold circuit, actual power value (which can be accurately measured with another instrument), or temperature are recorded and stored. Then, a second line is controlled to emit light, and data such as the monitoring value of the peak hold circuit, the actual power value, or the temperature are also recorded and stored, and so on. In this way, a relationship between the monitoring value of the peak hold circuit of each line and the actual power value of the laser is established, as shown in FIG. 6. In some other embodiments, the relationship between the monitoring value and the temperature is not limited to a linear relationship, and FIG. 6 is only shown as an example.

According to known calibration data, present laser output power value can be accurately measured based on the monitoring value of the peak hold circuit, the temperature, etc.

During working process, when each line emits light, after monitoring the laser power, the peak hold circuit will read a calibration value of a corresponding line at the corresponding temperature for comparison, and an error value is obtained, which will be used for compensation when the line emits light next time, so that the power can remain stable with different lines, different temperatures, and different working time.

In some embodiments, the ranging device also includes the scanner. The scanner is configured to change the transmission direction of the light pulse signal before emitting it, and the light pulse signal reflected by the object is incident to the photoelectric converter after passing through the scanner.

In some embodiments, the scanner includes the driver and the prism with uneven thickness. The driver is configured to drive the prism to rotate, so as to change the light pulse signal passing through the prism to different directions to emit.

In some embodiments, the scanner includes two drivers, and two prisms with uneven thicknesses arranged in parallel. The two drivers are respectively configured to drive the two prisms to rotate in opposite directions, and the light pulse signal from the light emission device changes the transmission direction to emit after sequentially passing through the two prisms.

In some other embodiments, the present disclosure also provides a ranging device including the light emission device, the light guide device, the first light reception device, and the second light reception device. The light emission device is configured to emit at least two light pulse sequences along different emission light paths. The second light reception device is configured to receive the light pulse signal reflected by the object, and determine the distance between the object and the ranging device based on the received light pulse signal. Part of the radiation power of the at least two light pulse sequences is incident to the light guide device, and the light guide device is configured to conduct the part of the radiation power to the first light reception device. The first light reception device is configured to monitor the output optical power of the light emission device.

In some embodiments, the light emission device is configured to emit at least two light pulse sequences along different emission light paths. In the at least two light pulse sequences, part of the radiation power of each light pulse sequence is incident to the light guide device at different times.

In some embodiments, the first light reception device includes a photoelectric converter configured to convert the optical signal into the electrical signal. The light guide device is configured to transmit the received radiation power to the same photoelectric converter in the first light reception device.

In some embodiments, the light emission device includes at least two laser diodes, and light emitting chips of the at least two laser diodes are packaged in same module.

In some embodiments, the light guide device includes the light incident surface, the reflection surface, and the light emission surface. The reflection surface includes the first reflection surface and the second reflection surface, and at least one of the first reflection surface or the second reflection surface has a curved surface shape.

In some embodiments, the first light reception device also includes the photoelectric converter, the peak hold circuit, and the sampling circuit. The photoelectric converter is configured to convert the optical signal received by the first light reception device into the electrical signal. The peak hold circuit is configured to hold the peak value of the electrical signal. The sampling circuit is configured to sample the peak value of the electrical signal.

In some embodiments, the peak hold circuit includes the first voltage follower, the capacitor, the second voltage follower, and the reset switch. The first voltage follower is configured to store the voltage signal measured by the photoelectric converter in the capacitor. The second voltage follower is configured to input the voltage signal of the capacitor to the sampling circuit. The reset switch is configured to reset the capacitor before each light pulse is emitted.

In some embodiments, the peak power obtained by the first laser diode is configured to adjust the next light emission power of the first laser diode, or is configured to adjust the light emission power of the second laser diode after the first laser diode.

In some embodiments, the ranging device also includes the scanner. The scanner is configured to change the transmission direction of the light pulse signal before emitting it, and the light pulse signal reflected by the object is incident to the photoelectric converter after passing through the scanner.

In some embodiments, the scanner includes the driver and the prism with uneven thickness. The driver is configured to drive the prism to rotate, so as to change the light pulse signal passing through the prism to different directions to emit.

In some embodiments, the scanner includes three drivers, and three prisms with uneven thicknesses arranged in parallel. The three drivers are respectively configured to drive the three prisms to rotate in opposite directions, and the light pulse signal from the light emission device changes the transmission direction to emit after sequentially passing through the three prisms.

In some other embodiments, the present disclosure also provides a mobile platform including any ranging device consistent with the present disclosure and a platform body. The ranging device is mounted at the platform body. For example, the mobile platform includes at least one of a manned aircraft, an unmanned aerial vehicle, a car, a robot, or a remote control vehicle.

According to the above-described ranging device and mobile platform provided by the present disclosure, the light path structure of the light guide device is designed or the non-signal reflected light in the light path system is directly used, so that a single PD and the same peak hold circuit are employed to perform the time-sharing monitoring of the multi-line laser power. The monitored signal is compared with the target power, and the error value is used to adjust the emission power in real time, so as to ensure the consistency of the temperature, working time, and different lines of the emission power. In the above scheme of the laser power monitoring, the power changes of the multi-line laser diodes can be effectively monitored, so as to monitor or dynamically adjust the working status of the system.

The technical terms used in the embodiments of the present disclosure are only used to describe specific embodiments and are not intended to limit the present disclosure. As used herein, the singular forms “a,” “an,” and “the” are used to include the plural forms as well, unless the context clearly indicates otherwise. Further, the terms “include” and/or “including” used in the specification refer to the presence of the described features, integers, steps, operations, elements, and/or components, but do not exclude the presence or addition of one or more other features, integers, steps, operations, elements, and/or components.

The corresponding structures, materials, actions, and equivalents (if any) of all devices or steps and functional elements in the appended claims are intended to include any structure, material, or action for performing the function in combination with other explicitly claimed elements. The description of the present disclosure is presented for the purpose of examples and description, but is not intended to be exhaustive or to limit the present disclosure to the disclosed form. Various modifications and variations will be apparent to those skilled in the art without departing from the scope and spirit of the present disclosure. The embodiments described in the present disclosure can better disclose the principles and practical applications of the present disclosure, and enable those skilled in the art to understand the present disclosure.

The flow chart described in the present disclosure is only an embodiment, and various modifications and changes can be made to the chart or the steps in the present disclosure without departing from the spirit of the present disclosure. For example, these steps can be performed in a different order, or some steps can be added, deleted, or modified. Those skill in the art can understand that implementing of all or part of the processes of the embodiments described above and equivalent changes made in accordance with the claims of the present disclosure still fall within the scope of the present disclosure.

What is claimed is:

1. A ranging device comprising:
a light emission device configured to emit a light pulse sequence;
a light guide device including a light incident surface, a reflection surface, and a light emission surface, the reflection surface including a first reflection surface and a second reflection surface, and at least one of the first reflection surface or the second reflection surface having a curved surface shape;
a first light reception device configured to monitor an output optical power of the light emission device; and
a second light reception device configured to receive a light pulse signal reflected by an object, and determine a distance between the object and the ranging device based on the light pulse signal;
wherein the light guide device is configured to receive part of radiation power emitted by the light emission device and conduct the part of the radiation power to the first light reception device.

2. The ranging device of claim 1, wherein the light emission device includes at least two laser diodes, and transmission light paths of the at least two laser diodes are not parallel to each other.

3. The ranging device of claim 1, wherein the light emission device includes at least two laser diodes that are arranged along a straight line.

4. The ranging device of claim 3, wherein:
the light incident surface includes a cylindrical surface, incident light received by the light incident surface being perpendicular to the light incident surface; and
the straight line is parallel to a central axis of the cylindrical surface.

5. The ranging device of claim 1, wherein:
the light emission device includes at least two laser diodes emit light in sequence; and
the light guide device is configured to guide the light from each of the at least two laser diodes to the first light reception device.

6. The ranging device of claim 5, wherein the ranging device is configured to calibrate the at least two laser diodes according to an output power of the first light reception device.

7. The ranging device of claim 1, wherein:
the light emission device includes at least two laser diodes; and
the first reflection surface is configured to reflect light from the at least two laser diodes to vicinity of a same position.

8. The ranging device of claim 1, wherein the second reflection surface is configured to convert divergent light from the light emission device into parallel light.

9. The ranging device of claim 1, wherein:
the first reflection surface is closer to the light incident surface than the second reflection surface and has a curved surface shape; or
the second reception surface is closer to the light emission surface than the first reflection surface and has a curved surface shape.

10. The ranging device of claim 1, wherein:
the first reflection surface is closer to the light incident surface than the second reflection surface and has a circular paraboloid shape with a focal point being a mirror image point of a center position of the first light reception device with respect to the second reflection surface; or
the second reception surface is closer to the light emission surface than the first reflection surface and has a circular paraboloid shape with a focal point being a mirror image point of a center position of the light emission device with respect to the first reflection surface.

11. The ranging device of claim 1, further comprising:
a positioning member configured to fix a position of the light emission device and a position of the light guide device relative to each other.

12. The ranging device of claim 11, wherein the positioning member includes a circular ring, the light emission device being clamped in the circular ring.

13. The ranging device of claim 1, wherein the first light reception device includes:
a photoelectric converter configured to convert an optical signal received by the first light reception device into an electrical signal;
a peak hold circuit configured to hold a peak value of the electrical signal, and including a resistor, a capacitor, and a voltage follower circuit; and
a sampling circuit configured to sample the peak value of the electrical signal.

14. The ranging device of claim 13, wherein the resistor includes a sampling resistor, one end of the resistor being connected to the photoelectric converter and an input end of the voltage follower circuit, and another end of the resistor being grounded.

15. The ranging device of claim 13, wherein:
one end of the voltage follower circuit is connected to the resistor and the photoelectric converter, and another end of the voltage follower circuit is connected to a low-speed analog-to-digital converter, the low-speed analog-to-digital converter being configured to output a sampled peak power; and
the voltage follower circuit includes:
a first voltage follower configured to follow a voltage signal of the resistor and charge the capacitor using the voltage signal; and
a second voltage follower including a reset switch configured to control the second voltage follower to input a signal in the capacitor to the low-speed analog-to-digital converter.

16. The ranging device of claim 1, wherein:
the light emission device includes at least two laser diodes; and
the first light reception device is configured to monitor optical signals from different ones of the at least two laser diodes in a time-sharing monitoring manner.

17. The ranging device of claim 16, wherein a next light emission power of the light emission device is adjusted according to a previous light emission power measured by a peak hold circuit of the ranging device.

18. The ranging device of claim 16, further comprising:
a peak hold circuit;
wherein:
the at least two laser diodes include a first laser diode and a second laser diode that are configured to emit light in sequence; and
the peak hold circuit is configured to:
after the first laser diode emits light, obtain a peak power of the first laser diode; and
after the second laser diode emits light after the peak hold circuit is reset, obtain a peak power of the second laser diode.

19. The ranging device of claim 18, wherein the peak power of the first laser diode is used to adjust a next light emission power of the first laser diode, or to adjust a light emission power of the second laser diode after the first laser diode emits light.

20. A ranging device comprising:
a light emission device configured to emit at least two light pulse sequences along different emission light paths;
a light guide device;
a first light reception device configured to monitor an output optical power of the light emission device; and
a second light reception device configured to receive a light pulse signal reflected by an object, and determine a distance between the object and the ranging device based on the received light pulse signal;
wherein the light guide device is configured to receive part of radiation power of the at least two light pulse sequences and conduct the part of the radiation power to the first light reception device.
